(19) United States
(12) Patent Application Publication
(10) Pub. No.: US 2014/0321473 A1
(43) Pub. Date: Oct. 30, 2014

(54) ACTIVE OUTPUT BUFFER CONTROLLER FOR CONTROLLING PACKET DATA OUTPUT OF MAIN BUFFER IN NETWORK DEVICE AND RELATED METHOD

(71) Applicant: MEDIATEK INC., Hsin-Chu (TW)

(72) Inventors: Yu-Hsun Chen, Hsinchu County (TW); Yi-Hsin Yu, Hsinchu County (TW); Ming-Shi Liou, Taipei City (TW); Ming Zhang, San Jose, CA (US)

(73) Assignee: MEDIATEK INC., Hsin-Chu (TW)

(21) Appl. No.: 14/230,005

(22) Filed: Mar. 31, 2014

Related U.S. Application Data
(60) Provisional application No. 61/816,252, filed on Apr. 26, 2013.

(51) Int. Cl. H04L 12/861

(52) U.S. Cl. CPC H04L 49/90
USPC 370/417

(57) ABSTRACT

An active output buffer controller is used for controlling a packet data output of a main buffer in a network device. The active output buffer controller has a credit evaluation circuit and a control logic. The credit evaluation circuit estimates a credit value based on at least one of an ingress data reception status of the network device and an egress data transmission status of the network device. The control logic compares the credit value with a first predetermined threshold value to generate a comparison result, and controls the packet data output of the main buffer according to at least the comparison result.

### CROSS REFERENCE TO RELATED APPLICATIONS

This application claims the benefit of U.S. provisional application No. 61/816,252, filed on Apr. 26, 2013 and incorporated herein by reference.

### BACKGROUND

The disclosed embodiments of the present invention relate to forwarding packets, and more particularly, to an active output buffer controller for actively controlling a packet data output of a main buffer in a network device and related method.

A network switch is a computer networking device that links different electronic devices. For example, the network switch receives an incoming packet generated from a source electronic device connected to it, and transmits an outgoing packet derived from the received packet to one or more destination electronic devices for which the received packet is meant to be received. In general, the network switch has a main buffer (i.e., a packet buffer) for buffering packet data of packets received from ingress ports, and forwards the packets stored in the main buffer through egress ports.

When a packet in the main buffer is ready to be forwarded to an egress port, the packet data is loaded from the main buffer, across an egress pipeline, into a first-in first-out (FIFO) buffer in a media access control (MAC) layer device, and then output to a physical layer (PHY) device. Traditionally, the MAC device may need a large-sized FIFO buffer to absorb data overflow in worst cases, which will increases the die size and cost. In addition, to avoid FIFO overflow, the MAC layer device may apply back pressure to a main buffer controller to stop more packet data from loaded from the main buffer into the FIFO buffer of the MAC layer device. The back pressure mechanism is activated when an amount of data stored in the FIFO buffer of the MAC layer device reaches a threshold. There is latency of the back pressure process activation. Besides, there are still some data in the egress pipeline that will still enter the FIFO buffer of the MAC layer device after the packet data output from the main buffer is stopped by the back pressure mechanism. As a result, the FIFO overflow may still occur when the back pressure mechanism is used.

### SUMMARY

In accordance with exemplary embodiments of the present invention, an active output buffer controller for actively controlling a packet data output of a main buffer in a network device and related method are proposed to solve the above-mentioned problem.

According to a first aspect of the present invention, an exemplary active output buffer controller for controlling a packet data output of a main buffer in a network device is disclosed. The exemplary active output buffer controller includes a credit evaluation circuit and a control logic. The credit evaluation circuit is arranged to estimate a credit value based on at least one of an ingress data reception status of the network device and an egress data transmission status of the network device. The control logic is arranged to compare the credit value with a first predetermined threshold value to generate a comparison result, and control the packet data output of the main buffer according to at least the comparison result.

According to a second aspect of the present invention, an exemplary method for actively controlling a packet data output of a main buffer in a network device is disclosed. The exemplary method includes: estimating a credit value based on at least one of an ingress data reception status of the network device and an egress data transmission status of the network device; comparing the credit value with a first predetermined threshold value to generate a comparison result; and controlling the packet data output of the main buffer according to at least the comparison result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a network device using a proposed active output buffer control mechanism according to an embodiment of the present invention.

FIG. 2 is a diagram illustrating one exemplary implementation of the active output buffer controller shown in FIG. 1.

FIG. 3 is a diagram illustrating a calibration operation triggered by a back pressure event according to an embodiment of the present invention.

FIG. 4 is a diagram illustrating a calibration operation triggered by a deviation event according to an embodiment of the present invention.

FIG. 5 is a diagram illustrating a calibration operation triggered by a time-up event according to an embodiment of the present invention.

FIG. 6 is a flowchart illustrating a method for actively controlling a packet data output of a main buffer in a network device according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

One technical feature of the present invention is to actively control a packet data output of a main buffer in a network device (e.g., a packet buffer in a network switch/hub) by predicting a data storage status of a first-in first-out (FIFO) buffer of a media access control (MAC) layer device. In this way, the FIFO overflow can be predicted and avoided in advance by the proposed active output buffer control mechanism. Preferably, the proposed active output buffer control mechanism may collaborate with the conventional back pressure mechanism to offer better FIFO overflow avoidance for the MAC layer device. Moreover, a calibration mechanism may be employed to make the evaluated credit value (i.e., a predicted data storage status of the FIFO buffer of the MAC layer device) synchronized with the actual data storage status of the FIFO buffer of the MAC layer device. Further details of the proposed active output buffer control mechanism are described as below.

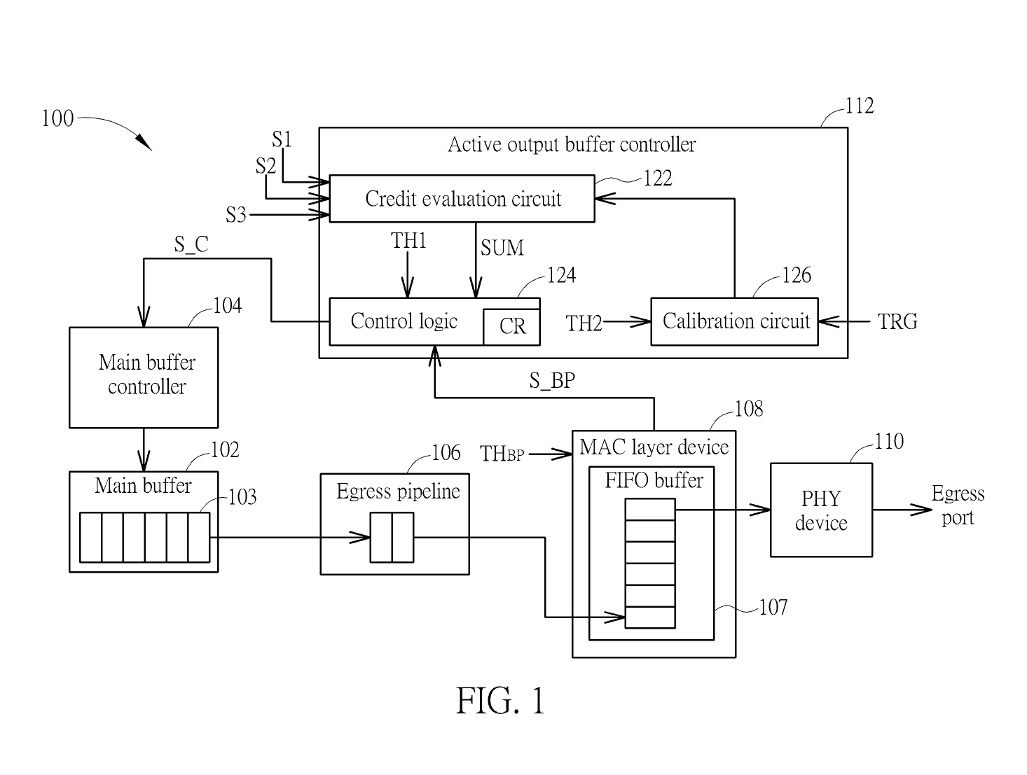

FIG. 1 is a diagram illustrating a network device using a proposed active output buffer control mechanism according to an embodiment of the present invention. In this embodiment, the network device 100 is a switch/hub including a main buffer (e.g., a packet buffer) 102, a main buffer controller 104, an egress pipeline 106, a MAC layer device 108 with a FIFO buffer 107, a PHY device 110, and an active output buffer controller 112. The egress pipeline 106, MAC layer device 108 and PHY device 110 are dedicated to forwarding packets through one egress port only. The main buffer 102 may receive ingress packets through an ingress pipeline (not shown), and store packet cells 103 of each ingress packet in a plurality of free storage spaces available in the main buffer 102. In a normal mode, one packet cell is treated as a basic unit that is output from the main buffer 102 in each clock cycle. That is, if the packet data output of the main buffer 102 for packet forwarding through the egress port is not paused for FIFO overflow avoidance, the main buffer 102 is controlled by the main buffer controller 104 to output one packet cell to the egress pipeline 106 in every clock cycle. The egress pipeline 106 is coupled between the main buffer 102 and the FIFO buffer 107. Therefore, even though the main buffer 102 stops its packet data output for packet forwarding through the egress port, it is possible that the egress pipeline 106 still has packet cells stored therein, and these packet cells will be sequentially output to the FIFO buffer 107. The PHY device 110 is coupled between the egress port and the MAC layer device 108, and is configured to output packet cells in the FIFO buffer 107 to the egress port.

In this embodiment, the active output buffer controller 112 is illustrated as a standalone engine externally coupled to the main buffer controller 104, and therefore provides an external control signal S_C to the main buffer controller 104 for actively controlling the packet data output of the main buffer 102 through instructing the main buffer controller 104. However, this is for illustrative purposes only, and is not meant to be a limitation of the present invention. In one alternative design, the active output buffer controller 112 may be integrated with the active output buffer controller 112 to be an embedded function of the main buffer controller 104, and therefore provides an internal control signal S_C for actively controlling the packet data output of the main buffer 102. In another alternative design, the active output buffer controller 112 may be integrated with a circuit element (e.g., the egress pipeline 106 or the MAC layer device 108) different from the active output buffer controller 112, and therefore provides an external control signal S_C to the main buffer controller 104 for actively controlling the packet data output of the main buffer 102 through instructing the main buffer controller 104. Briefly summarized, the proposed active output buffer control mechanism may be implemented in any place in the network device 100 as long as the same objective of actively controlling main buffer's packet data output associated with packet forwarding through an egress port is achieved. These feasible designs all fall within the scope of the present invention.

As shown in FIG. 1, the active output buffer controller 112 includes, but is not limited to, a credit evaluation circuit 122, a control logic 124 and a calibration circuit 126. The credit evaluation circuit 122 is a core circuit of the active output buffer controller 112, and is designed to predict a data storage status of the FIFO buffer 107 in the MAC layer device 108. For example, the active output buffer controller 112 may estimate a credit value SUM based on one or both of an ingress data reception status S1 of the network device 100 and an egress data transmission status S2 of the network device 100. For another example, the active output buffer controller 112 may estimate the credit value SUM based on an implementation specification S3, and at least one of an ingress data reception status S1 of the network device 100 and an egress data transmission status S2 of the network device 100.

By way of example, but not limitation, the implementation specification S3 may include at least one of a packet cell size, an operation frequency of the MAC layer device 108, and a time-division multiplexing (TDM) period for the egress port. More specifically, the packet cell size indicates the number of bytes/bits in each packet cell to be output from the main buffer 102 in one clock cycle. The TDM period for the egress port decides the number of clock cycles between two successive TDM slots each given to packet data transmission from the main buffer 102 to the following egress pipeline 106. The operation frequency of the MAC layer device 108 decides the egress through during one TDM period. Besides above-mentioned parameters, the implementation specification S3 is allowed to include other parameters.

By way of example, but not limitation, the ingress data reception status S1 may include at least one of an ingress data incoming rate, an ingress packet forwarding method, and an ingress pipeline depth. More specifically, the ingress data incoming rate indicates how many bits/bytes of the ingress packets are received by the network switch 100 per clock cycle. The ingress packet forwarding method specifies how to manipulate the packet forwarding. For example, the ingress packet may be forwarded in a store-and-forward (SF) manner or a cut-through (CT) manner, depending upon actual application consideration. The ingress pipeline depth specifies the maximum number of ingress packet cells that the ingress pipeline can accommodate. Besides above-mentioned parameters, the ingress data reception status S1 is allowed to include other parameters.

By way of example, but not limitation, the egress data transmission status S2 may include at least one of an egress pipeline depth, a FIFO size of the MAC layer device 108, a transmission rate of the PHY device 110, and egress packet size modification information. More specifically, the egress pipeline depth specifies the maximum number of egress packet cells that the egress pipeline 106 can accommodate. The FIFO size of the MAC layer device 108 specifies the maximum number of egress packet cells that the FIFO buffer 107 can accommodate. The transmission rate of the PHY device 110 indicates how many bits/bytes of the egress packets are delivered by the PHY device 110 per clock cycle. The egress packet size modification information indicates the size of additional information added to the egress packet data when the egress packet data travels from the main buffer 102 to the PHY device 110 and/or the size of auxiliary information removed from the egress packet data when the egress packet data travels from the main buffer 102 to the PHY device 110. Besides above-mentioned parameters, the egress data transmission status S2 is allowed to include other parameters.

The evaluated credit value SUM is indicative of a predicted data storage status of the FIFO buffer 107 in the MAC layer device 108. In one exemplary design, the credit value SUM maybe a predicted number of packets in the FIFO buffer 107. In another exemplary design, the credit value SUM may be a predicted number of bytes, half bytes, or ¼ bytes in the FIFO buffer 107. Further, the credit value SUM may have different weightings when the MAC layer device 108 has different operations. For example, the MAC layer device 108 may replicate packers/packet cells for multicast purpose. Thus, the credit value SUM should be adjusted to reflect the actual FIFO buffer utilization under the current operation of the MAC layer device 108.

The control logic 124 is arranged to compare the credit value SUM with a predetermined threshold value TH1 to generate a comparison result CR, and set a control signal S_C to control the packet data output of the main buffer 104 according to at least the comparison result CR. For example, when the comparison result CR indicates that the credit value SUM reaches the predetermined threshold value TH1, the control logic 124 judges that the free space available in the FIFO buffer 107 fails to meet a minimum safe margin and the undesired FIFO overflow might occur soon. Therefore, the control logic 124 asserts the control signal S_C (e.g., S_C=1) to instruct the main buffer controller 104 to pause the packet data output of the main buffer 102. After the packet data output of the main buffer 102 is paused, the FIFO buffer 107 will gradually release the occupied space by outputting the stored packet data to the following stage (i.e., the PHY device 110), and the credit value SUM will also be updated correspondingly. After the credit value SUM is decreased to a lower level, the control logic 124 judges that the FIFO buffer 107 gets rid of the undesired FIFO overflow threat now. Next, the control logic 124 deasserts the control signal S_C (e.g., S_C=0) to instruct the main buffer controller 104 to resume the packet data output of the main buffer 102, thus allowing new packet cell data to be forwarded through the egress port.

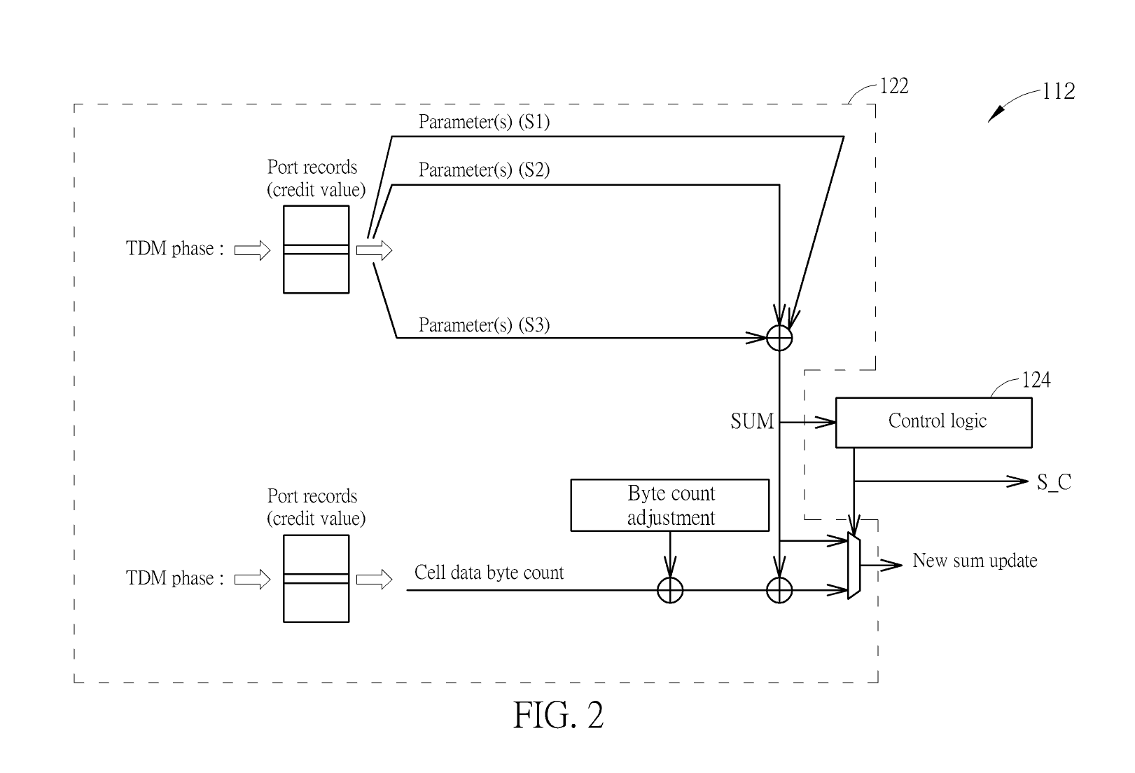

Please refer to FIG. 2, which is a diagram illustrating one exemplary implementation of the active output buffer controller 112 shown in FIG. 1. Parameters belonging to the above-mentioned ingress data reception status S1, egress data transmission status S2 and implementation specification S3 are combined with the credit value derived from the last TDM slot. It should be noted that, based on definitions of the parameters, one or more of the parameters may apply increment to the credit value derived from the last TDM slot, and/or one or more of the parameters may apply decrement to the credit value derived from the last TDM slot. The resulting credit value SUM is checked by the control logic 124 to set the control signal S_C.

When the credit value SUM does not exceed the safe margin yet, the credit value SUM is updated by the packet cell data byte count and then stored back to the port records to serve as a credit value derived from a last TDM slot later. However, when the credit value SUM exceed the safe margin (or a back pressure event occurs, if the back pressure mechanism is employed by the MAC layer device), the credit value SUM is not updated by the packet cell data byte count, and is directly stored back to the port records to serve as a credit value derived from a last TDM slot later.

In addition, regarding an end of a packet (EOP), additional bytes may be appended to the packet by the MAC layer device 108 to separate the packet and the next packet; and regarding a start of a packet (SOP), auxiliary bytes may be removed from a header of the packet by the MAC layer device 108 due to the fact that the auxiliary bytes provide auxiliary information for the MAC layer device 108 only, and will not be forwarded to a destination electronic device through the egress port. Thus, the packet cell data byte count for a current TDM slot may be adjusted for EOP and SOP.

As mentioned above, when the comparison result CR indicates that the credit value SUM reaches the predetermined threshold value TH1, the control logic 124 would assert the control signal S_C to instruct the main buffer controller 104 to pause the packet data output of the main buffer 102, thus stopping new packet data to be forwarded through the egress port from entering the egress pipeline 106. In contrast to pausing the packet data output of the main buffer 102 at a boundary of a packet to be forwarded, the control logic 124 may be configured to pause the packet data output of the main buffer 102 at a boundary of a packet cell within one packet to be forwarded. That is, in contrast to prohibiting a packet from being partially output to the egress pipeline 106 when the packet data output is paused, the main buffer 102 is allowed to output one or more packet cells of a packet to the egress pipeline 106 when the packet data output is paused. In this way, the egress pipeline and the FIFO buffer can be utilized more efficiently to offer better egress throughput performance. In a case where the egress pipeline and the FIFO buffer support smaller granularity, when the comparison result CR indicates that the credit value SUM reaches the predetermined threshold value TH1, the control logic 124 may pause the packet data output of the main buffer 102 at a boundary of a fraction of a packet cell within one packet to be forwarded.

As mentioned above, the credit value SUM is obtained by predicting the data storage status of the FIFO buffer 107 in the MAC layer device 108. Therefore, it is possible that the credit value SUM indicative of the predicted data storage status of the FIFO buffer 107 in the MAC layer device 108 is deviated from the actual data storage status of the FIFO buffer 107 in the MAC layer device 108. In a worst case, the credit value SUM may be far below the predetermined threshold value TH1 when the FIFO buffer 107 is almost full. To avoid this, the conventional back pressure mechanism may be employed by the MAC layer device 108 to monitor the actual data storage status of the FIFO buffer 107 in the MAC layer device 108, and assert a back pressure signal S_BP when the actual amount of data stored in the FIFO buffer 107 reaches a predetermined threshold value TH_{BP}. Therefore, when the control logic 124 judges that the credit value SUM does not reach the predetermined threshold value TH1, the control logic 124 further checks if there is the back pressure signal S_BP asserted by the MAC layer device 108. The control signal S_C is still asserted to instruct the main buffer controller 104 to pause the packet data output of the main buffer 102 when the back pressure signal S_BP is asserted under a condition that the credit value SUM does not reach the predetermined threshold value TH1.

Preferably, the present invention further proposes a calibration mechanism used to avoid/mitigate the problem caused by the underestimated credit value SUM. Specifically, when a specific event TRG is triggered, the calibration circuit 126 is operative to calibrate the credit value SUM based on an actual amount of data in the FIFO buffer 107 of the MAC layer device 108. For example, the calibration circuit 126 calibrates the credit value SUM by synchronizing the credit value SUM with the actual amount of data in the FIFO buffer 107, i.e., re-aligning the credit value SUM with the actual amount of data in the FIFO buffer 107. Several exemplary designs of the proposed calibration mechanism are given as below.

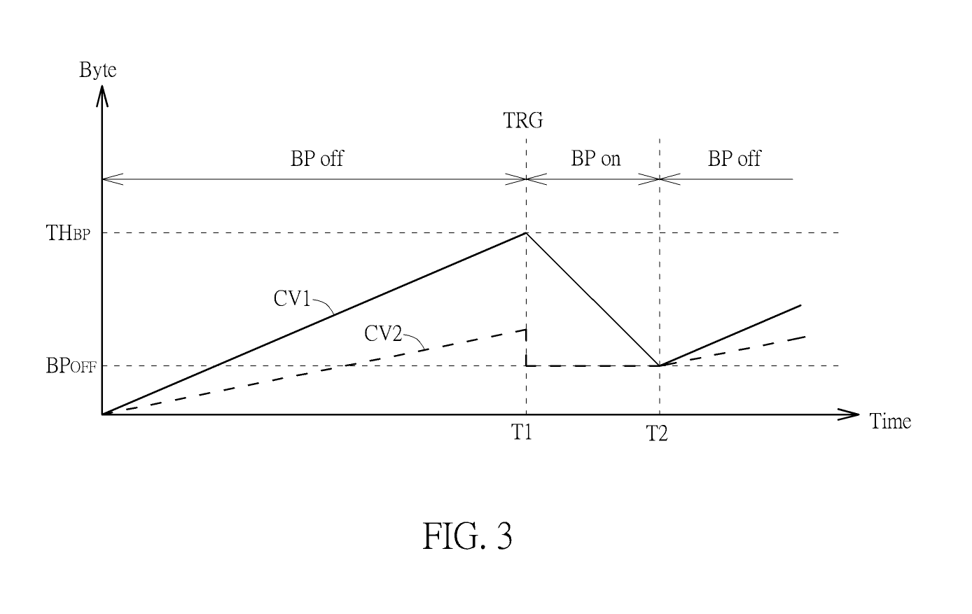

In a first exemplary calibration design, the calibration circuit 126 calibrates the credit value SUM in response to the back pressure signal S_BP asserted by the MAC layer device 108. In other words, the specific event TRG is a back pressure event that is triggered each time the back pressure mechanism is activated by the MAC layer device 108 for FIFO overflow avoidance. Please refer to FIG. 3, which is a diagram illustrating a calibration operation triggered by a back pressure event according to an embodiment of the present invention. The characteristic curve CV1 indicates the amount of data stored in the FIFO buffer 107 of the MAC layer device 108, and the characteristic curve CV2 indicates the credit value SUM evaluated and recorded by the active output buffer controller 112. Since the proposed active buffer control mechanism might be more cautious about FIFO overflow judgment (i.e., the proposed active buffer control mechanism is more likely to underestimate the credit value), thus resulting in mismatch between the evaluated credit value SUM and the actual amount of data stored in the FIFO buffer 107 of the MAC layer device 108. In this example, the credit value SUM is accumulated in a slower rate, and, the actual data in the FIFO buffer 107 will be accumulated in a faster rate. As a result, the back pressure event might happen before the credit value SUM reaches the predetermined threshold value TH1. As shown in FIG. 3, the amount of data in the FIFO buffer 107 reaches the predetermined threshold value TH_{BP} at time T1. Hence, the MAC layer device 108 asserts the back pressure signal S_BP, such that the calibration circuit 126 is triggered by the specific event (i.e., a back pressure event) TRG.

When the back pressure process is in effect, the packet data output of the main buffer 102 for the egress port is paused. However, the FIFO buffer 107 still works normally to supply a packet data output to the PHY device 110, thus allowing the amount of data in the FIFO buffer 107 to decrease. When the amount of data in the FIFO buffer 107 is reduced to a specific value BP_{OFF} at time T2, the MAC layer device 108 deasserts the back pressure signal S_BP to deactivate the back pressure mechanism, thereby allowing the main buffer 102 to resume the packet data output.

After triggered by the specific event TRG, the calibration circuit 126 is operative to ensure that the credit value SUM will be synchronized with the amount of data in the FIFO buffer 107 at time T2 (i.e., the timing when the packet data output of the main buffer 102 is resumed). In this embodiment, the calibration circuit 126 immediately sets the credit value SUM by the specific value BP_{OFF} at time T1, and then holds the credit value SUM until the back pressure mechanism is deactivated at time T2. Hence, the credit value SUM is re-aligned with the actual amount of data in the FIFO buffer 107 at time T2. It should be noted that the example shown in FIG. 3 is not meant to be a limitation of the present invention. For example, the calibration circuit 126 may set the credit value SUM by the specific value BP_{OFF OFF} at any time point between T1 and T2, and then hold the credit value SUM until the back pressure mechanism is deactivated at time T2. The same objective of synchronizing the credit value SUM with the actual amount of data in the FIFO buffer 107 is achieved.

In a second exemplary calibration design, the calibration circuit 126 further monitors a difference between the credit value SUM and the actual amount of data in the FIFO buffer 107 of the MAC layer device 107. For example, the calibration circuit 126 may employ a software module (i.e., a monitor program) or a hardware module (e.g., a watchdog device) to check if the difference reaches the predetermined threshold value TH2. When the difference reaches the predetermined threshold value TH2, meaning that the credit value SUM should be adjusted to keep pace with the actual amount of data in the FIFO buffer 107, the specific event TRG is triggered to enable the calibration circuit 126.

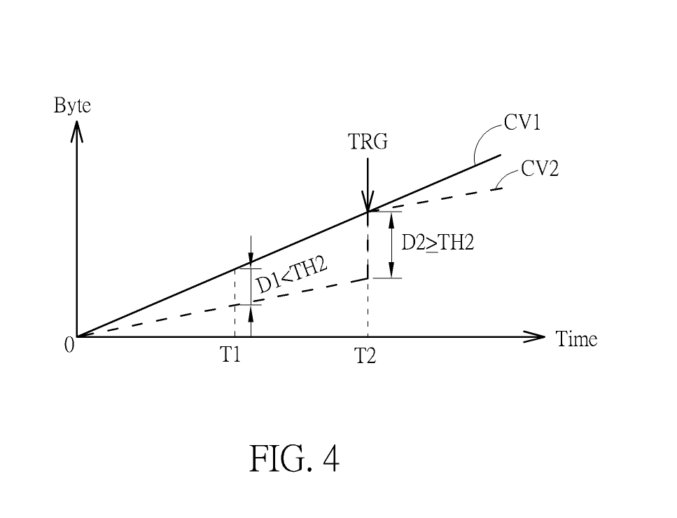

Please refer to FIG. 4, which is a diagram illustrating a calibration operation triggered by a deviation event according to an embodiment of the present invention. The characteristic curve CV1 indicates the amount of data in the FIFO buffer 107 of the MAC layer device 108, and the characteristic curve CV2 indicates the credit value SUM evaluated and recorded by the active output buffer controller 112. As mentioned above, the proposed active buffer control mechanism might be cautious about FIFO overflow judgment, thus resulting in mismatch between the evaluated credit value SUM and the actual amount of data stored in the FIFO buffer 107 of the MAC layer device 108. In this example, the credit value SUM is accumulated in a slower rate, and the actual data in the FIFO buffer 107 is accumulated in a faster rate. In this embodiment, the difference between the credit value SUM and the actual amount of data in the FIFO buffer 107 increases gradually. At time T1, the difference D1 between the credit value SUM and the actual amount of data in the FIFO buffer 107 does not reach the predetermined threshold value TH2 yet, no calibration is needed to synchronize the credit value SUM with the actual amount of data in the FIFO buffer 107. However, at time T2, the monitor program/watchdog device of the calibration circuit 126 detects that the difference D2 between the credit value SUM and the actual amount of data in the FIFO buffer 107 reaches the predetermined threshold value TH2, the calibration circuit 126 is therefore triggered by the specific event (i.e., a deviation event) TRG to calibrate the credit value SUM, thus re-aligning the credit value SUM with the actual amount of data in the FIFO buffer 107.

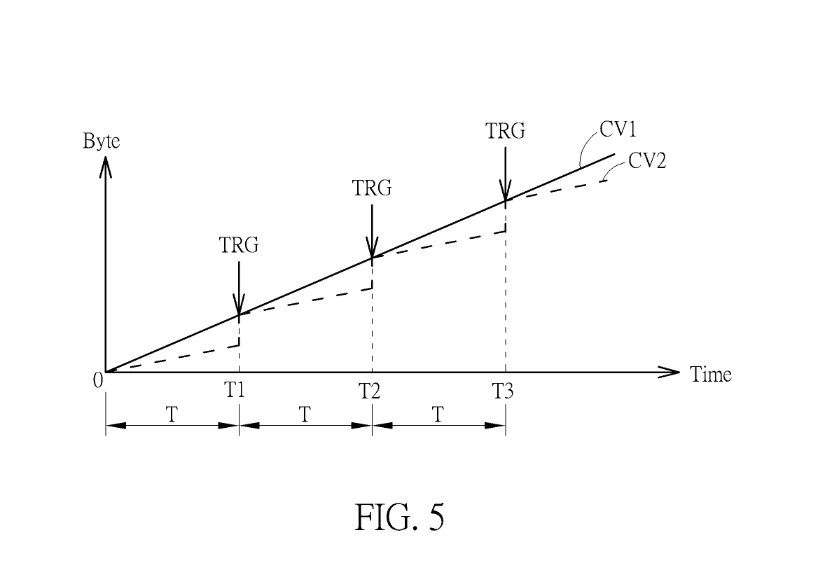

In a third exemplary calibration design, the calibration circuit 126 calibrates the credit value SUM when a predetermined timing criterion is met. By way of example, but not limitation, the calibration circuit 126 may calibrate the credit value SUM, periodically. For example, the calibration circuit 126 may employ a software module (i.e., a monitor program) or a hardware module (e.g., a watchdog device) to count a predetermined period of time T, and triggers a time-up event each time the predetermined period of time T is expired. In other words, when the predetermined period of time T is expired, meaning that the credit value SUM should be adjusted now, the specific event TRG is triggered to enable the calibration circuit 126. Please refer to FIG. 5, which is a diagram illustrating a calibration operation triggered by a time-up event according to an embodiment of the present invention. The characteristic curve CV1 indicates the amount of data in the FIFO buffer 107 of the MAC layer device 108, and the characteristic curve CV2 indicates the credit value SUM evaluated and recorded by the active output buffer controller 112. As mentioned above, the proposed active buffer control mechanism might be cautious about FIFO overflow judgment, thus resulting in mismatch between the evaluated credit value SUM and the actual amount of data stored in the FIFO buffer 107 of the MAC layer device 108. In this example, the credit value SUM is accumulated in a slower rate, and the actual data in the FIFO buffer 107 is accumulated in a faster rate. In this embodiment, the predetermined period of time T is expired at time T1, T2 and T3. Thus, the calibration circuit 126 is periodically triggered by the specific event (i.e., a time-up event) TRG to calibrate the credit value SUM, thus re-aligning the credit value SUM with the actual amount of data in the FIFO buffer 107 at time T1, T2 and T3, respectively.

In above examples shown in FIG. 4 and FIG. 5, the credit value SUM is accumulated in a slower rate, and the actual data in the FIFO buffer 107 is accumulated in a faster rate. However, these are for illustrative purposes only, and are not meant to be limitations of the present invention. Actually, the mismatch between the evaluated credit value SUM and the actual amount of data in the FIFO buffer 107 cannot be predicted beforehand. That is, the evaluated credit value SUM may be smaller than the actual amount of data in the FIFO buffer 107 at one time point, but maybe larger than the actual amount of data in the FIFO buffer 107 at another time point. Therefore, the adjustment made to the evaluated credit value SUM by the calibration circuit 126 may be an increment or a decrement, depending upon the instant relation between the evaluated credit value SUM and the actual amount of data in the FIFO buffer 107.

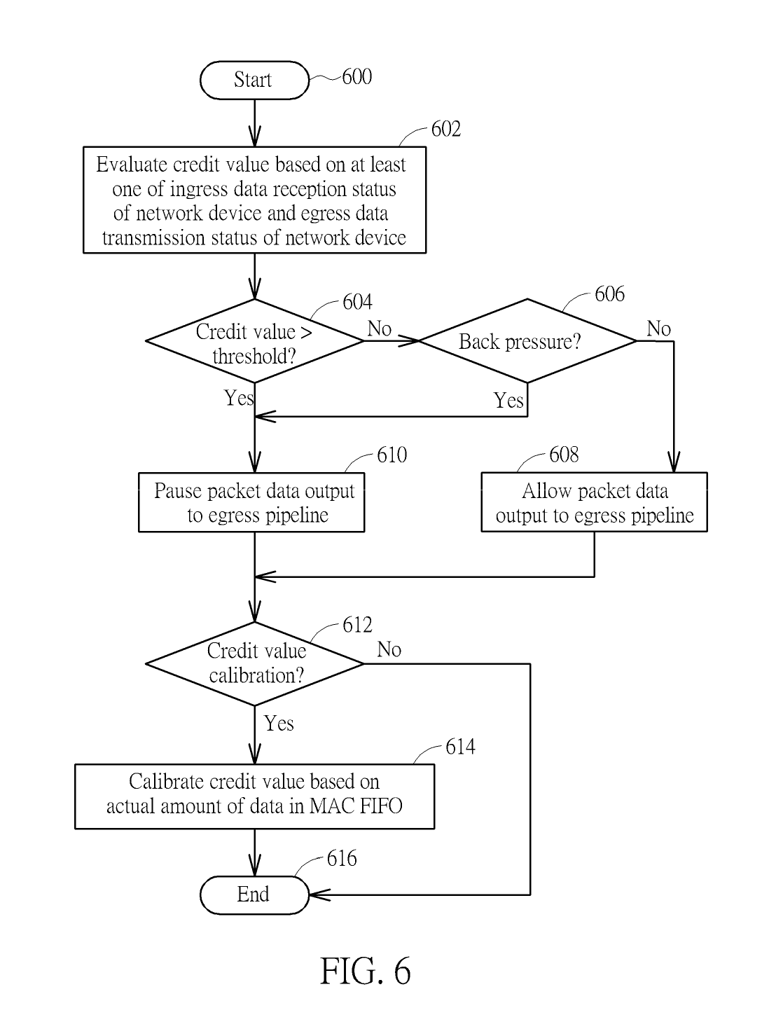

FIG. 6 is a flowchart illustrating a method for actively controlling a packet data output of a main buffer in a network device according to an embodiment of the present invention. Provided that the result is substantially the same, the steps are not required to be executed in the exact order shown in FIG. 6. The exemplary method may be employed by the active output buffer controller 112 shown in FIG. 1, and may be briefly summarized as follows.

Step 600: Start.

Step 602: Evaluate a credit value based on at least one of an ingress data reception status of the network device and an egress data transmission status of the network device. In some designs of the present invention, an implementation specification may be further referenced by evaluation of the credit value.

Step 604: Check if the credit value reaches a predetermined threshold value. If yes, go to step 610; otherwise, go to step 606.

Step 606: Check if a back pressure signal is asserted. If yes, go to step 610; otherwise, go to step 608.

Step 608: Allow a main buffer to generate a packet data output to an egress pipeline. Go to step 612.

Step 610: Control the main buffer to pause the packet data output.

Step 612: Check if there is a specific event for credit value calibration. If yes, go to step 614; otherwise, go to step 616.

Step 614: Calibrate the credit value based on an actual amount of data in a FIFO buffer of a MAC layer device. For example, the credit value is calibrated by synchronizing the credit value with the actual amount of data in the FIFO buffer of the MAC layer device.

Step 616: End.

As a person skilled in the art can readily understand details of each step after reading above paragraphs, further description is omitted here for brevity.

It should be noted that the active output buffer controller 112 in FIG. 1 and the related method in FIG. 6 are for illustrative purposes only, and are not meant to be limitations of the present invention. That is, the active output buffer controller 112 in FIG. 1 and the related method in FIG. 6 may be modified without departing from the spirit of the present invention. For example, the back pressure mechanism may be omitted from the MAC layer device 108. Hence, the active output buffer controller 112 is modified to set the control signal S_C based on the credit value SUM without referring to the back pressure signal S_BP. For another example, the calibration circuit 126 may be omitted from the active output buffer controller 112. Hence, the active output buffer controller 112 is modified to set the control signal S_C based on the credit value SUM with no calibration applied thereto. These alternative designs all fall within the scope of the present invention.

With the use of the proposed active output buffer controller, a high FIFO utilization can be achieved by properly controlling the packet data flow between the main buffer and the MAC layer device. Besides, since the proposed active output buffer controller is capable of actively preventing the MAC layer device from having the undesired FIFO overflow, the back pressure mechanism may be omitted for lowering the routing complexity, and/or the FIFO size in the MAC layer device may be reduced for cost reduction.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An active output buffer controller for controlling a packet data output of a main buffer in a network device, the active output buffer controller comprising:
a credit evaluation circuit, arranged to estimate a credit value based on at least one of an ingress data reception status of the network device and an egress data transmission status of the network device; and
a control logic, arranged to compare the credit value with a first predetermined threshold value to generate a comparison result, and control the packet data output of the main buffer according to at least the comparison result.

2. The active output buffer controller of claim 1, wherein the credit evaluation circuit is further arranged to refer to an implementation specification when estimating the credit value.

3. The active output buffer controller of claim 2, wherein the implementation specification includes at least one of a packet cell size, an operation frequency of a media access control (MAC) layer device, and a time-division multiplexing (TDM) period for an egress port.

4. The active output buffer controller of claim 1, wherein the ingress data reception status includes at least one of an ingress data incoming rate, an ingress packet forwarding method, and an ingress pipeline depth.

5. The active output buffer controller of claim 1, wherein the egress data transmission status includes at least one of an egress pipeline depth, a first-in first-out (FIFO) size of a media access control (MAC) layer device, a transmission rate of a physical layer (PHY) device, and egress packet size modification information.

6. The active output buffer controller of claim 1, wherein when the comparison result indicates that the credit value reaches the first predetermined threshold value, the control logic pauses the packet data output of the main buffer at a boundary of a packet cell within one packet to be forwarded.

7. The active output buffer controller of claim 1, wherein when the comparison result indicates that the credit value reaches the first predetermined threshold value, the control logic pauses the packet data output of the main buffer at a boundary of a fraction of a packet cell within one packet to be forwarded.

8. The active output buffer controller of claim 1, wherein when the comparison result indicates that the credit value does not reach the first predetermined threshold value, the control logic is further arranged to generate a checking result by checking if a back pressure signal is asserted by a media access control (MAC) layer device, and control the packet data output of the main buffer according to the checking result.

9. The active output buffer controller of claim 1, further comprising:
a calibration circuit, arranged to calibrate the credit value based on an actual amount of data in a first-in first-out (FIFO) buffer of a media access control (MAC) layer device.

10. The active output buffer controller of claim 9, wherein the calibration circuit calibrates the credit value by synchronizing the credit value with the actual amount of data in the FIFO buffer of the MAC layer device.

11. The active output buffer controller of claim 9, wherein the calibration circuit calibrates the credit value in response to a back pressure signal asserted by the MAC layer device.

12. The active output buffer controller of claim 9, wherein the calibration circuit is further arranged to monitor a difference between the credit value and the actual amount of data in the FIFO buffer of the MAC layer device; and the calibration circuit calibrates the credit value when the difference reaches a second predetermined threshold value.

13. The active output buffer controller of claim 9, wherein the calibration circuit calibrates the credit value when a predetermined timing criterion is met.

14. A method for controlling a packet data output of a main buffer in a network device, the method comprising:
estimating a credit value based on at least one of an ingress data reception status of the network device and an egress data transmission status of the network device;
comparing the credit value with a first predetermined threshold value to generate a comparison result; and
controlling the packet data output of the main buffer according to at least the comparison result.

15. The method of claim 14, wherein the step of estimating the credit value further comprises:
referring to an implementation specification when estimating the credit value.

16. The method of claim 15, wherein the implementation specification includes at least one of a packet cell size, an operation frequency of a media access control (MAC) layer device, and a time-division multiplexing (TDM) period for an egress port.

17. The method of claim 14, wherein the ingress data reception status includes at least one of an ingress data incoming rate, an ingress packet forwarding method, and an ingress pipeline depth.

18. The method of claim 14, wherein the egress data transmission status includes at least one of an egress pipeline depth, a first-in first-out (FIFO) size of a media access control (MAC) layer device, a transmission rate of a physical layer (PHY) device, and egress packet size modification information.

19. The method of claim 14, wherein the step of controlling the packet data output of the main buffer comprises:
when the comparison result indicates that the credit value reaches the first predetermined threshold value, pausing the packet data output of the main buffer at a boundary of a packet cell within one packet to be forwarded.

20. The method of claim 14, wherein the step of controlling the packet data output of the main buffer comprises:
when the comparison result indicates that the credit value reaches the first predetermined threshold value, pausing the packet data output of the main buffer at a boundary of a fraction of a packet cell within one packet to be forwarded.

21. The method of claim 14, wherein the step of controlling the packet data output of the main buffer comprises:
when the comparison result indicates that the credit value does not reach the first predetermined threshold value, generating a checking result by checking if a back pressure signal is asserted by a media access control (MAC) layer device, and controlling the packet data output of the main buffer according to the checking result.

22. The method of claim 14, further comprising:
calibrating the credit value based on an actual amount of data in a first-in first-out (FIFO) buffer of a media access control (MAC) layer device.

23. The method of claim 22, wherein the step of calibrating the credit value comprises:
synchronizing the credit value with the actual amount of data in the FIFO buffer of the MAC layer device.

24. The method of claim 22, wherein the credit value is calibrated in response to a back pressure signal asserted by the MAC layer device.

25. The method of claim 22, wherein the step of calibrating the credit value comprises:
monitoring a difference between the credit value and the actual amount of data in the FIFO buffer of the MAC layer device; and
calibrating the credit value when the difference reaches a second predetermined threshold value.

26. The method of claim 22, wherein the credit value is calibrated when a predetermined timing criterion is met.
